(19) United States
(12) Patent Application Publication
(10) Pub. No.: US 2022/0327478 A1
(43) Pub. Date: Oct. 13, 2022

(54) SYSTEM AND METHOD FOR COMMODITY TERMINAL ORDER AUTOMATION

(71) Applicant: Hoss Industries, LLC, Fair Haven, NJ (US)

(72) Inventors: Andrew Joseph Stypa, Fair Haven, NJ (US); Mark Severn Fiorillo, Coral Springs, FL (US)

(21) Appl. No.: 17/685,677

(22) Filed: Mar. 3, 2022

Related U.S. Application Data
(60) Provisional application No. 63/174,248, filed on Apr. 13, 2021.

(51) Int. Cl. G06Q 10/08

(52) U.S. Cl. CPC G06Q 10/0838; G06Q 10/0875

(57) ABSTRACT

A system provides for efficient and hassle-free loading of fluids and physical goods from a terminal into tankers and/or compartments and transporting the goods to multiple retail stations and end-users with minimum manual errors. The system generates an automation source based on an order from a customer. The automation source is then used for goods distribution at different junctions.

### CROSS-REFERENCE TO RELATED APPLICATIONS

The present application claims the benefit of U.S. Provisional Patent Application No. 63/174,248, filed on Apr. 13, 2021, the entire contents of which are hereby incorporated herein by reference.

### BACKGROUND

### Field of Invention

Aspects disclosed herein relate, in general, to methods and systems for managing good transportation and, more particularly, to methods and systems for distributing various goods of varying quantities between different facilities by using a vehicle.

### Description of Related Art

Generally, goods such as, but not limited to, fluids, gases, liquids, physical commodities such as grains and so forth are distributed through a third-party agency that transports these goods from a terminal to a retailer or end user by using trucks or similar transportation systems. During the goods distribution, coordination between a dealer (e.g., a commodity terminal, hauler, etc.) and a customer (e.g., retailers) is important. For example, conventional fuel distribution systems enable truck drivers to manually perform order entry and fluid distribution at every junction such as terminals, retail stations, and so forth. However, drivers may sometimes unknowingly commit mistakes such as, a wrong data entry, which can cause a lot of damage either to the dealer or to the customer(s). In addition, conventional fuel distribution systems are complex and are at high risk of human errors.

Further, conventional fuel distribution systems require human intervention for order entry and fluid distribution and require proper training to handle such systems without any error, as these systems are complex to use. Currently, customers order fuel from a web portal where upon receiving the order, an order ticket is generated, which includes details which need to be manually typed into the terminal's dispatching system. A truck tanker driver takes a printout of the ticket and head towards the mentioned terminal for loading the tanker. The fuel distribution industry is an example of an industry where problems exist. At the terminal, the truck tanker driver has to manually input critical details such as, but not limited to, a fuel type (for example, 87 Gasoline, 89 Gasoline, 93 Gasoline, Diesel, etc.), a quantity of each fuel type, and a counterparty to pull fuel from/into a number of terminal systems, etc. while trying to operate as efficiently/quickly as possible which increases the risk of human errors. After the loading process is completed at the terminal, the truck driver heads towards a retail station (referred to as a customer who ordered the fuel) to deliver the fuel. After the fuel delivery, the customer is prompted to digitally sign a delivery acknowledgement and the customer instantly receives an electronic receipt of the transaction. All the above discussed process starting from loading to unloading of the good, includes a lot of human intervention thus mistakes are inevitable.

Thus, there is a need for an efficient and more reliable system with minimum human interference to execute such transfers and reduce the risk of human errors.

### SUMMARY

Aspects in accordance with the technology of the present disclosure provide a system and a method to automate terminal goods distribution, for example, commodity terminal orders by using potential automation sources such as, but not limited to, a Quick Response Code (QR Code), a Radio Frequency Identifiers (RFIs), and a License Plate Scanning based system. The terminal goods distribution system may be used for efficient, hassle-free loading and transportation of goods, for example, fuel, gas or so forth from a terminal to a number of retail stations with minimum human intervention, and thus eliminating human errors caused to a great extent.

The technology of the present disclosure uses one or a combination of the above mentioned automation sources to execute an order. After a customer places an order, an order receipt is embedded into an automation source. The automation source is either printed or transferred to the truck driver as an order ticket that contains all details about the order, such as but not limited to, a fuel, chemical, commodity or goods type(s), the associated quantities, terminal details, a counterparty to pull the goods from, retail station details, etc.

Aspects in accordance with the technology of the present disclosure further provide a fuel distribution system that uses a potential automation source such as a Quick Response Code (QR code) for automating the process of terminal orders. The QR Code may be printed or sent wirelessly to a truck driver. The truck driver may scan the QR code by using any QR Code scanner and then the order details may be received by the driver. Further, the order details of the QR code may be relayed, by a computer-readable program, to a terminal. The order details may be, but are not limited to, what goods to dispense, how much of each of the goods to dispense, and what counterparty to pull from, and so forth. In addition, the computer-readable program may start automatic processing of accounting documents, such as invoices and receivables related to the order. The computer-readable program may, therefore, eliminate various technical errors due to manual data inputs into a keypad system.

Aspects in accordance with the technology of the present disclosure further provide a fuel distribution system that uses a potential automation source, such as a Radio Frequency Identifiers (RFIs) that may be carried by a truck driver. Further, the RFI may be scanned, and the order details may be relayed, by a computer-readable program, to a terminal. In addition, the computer-readable program may start automatic processing of accounting documents, such as invoices and receivables related to the order. The computer-readable program may eliminate various technical errors due to manual inputs into a keypad system.

Aspects in accordance with the technology of the present disclosure further provide a fuel distribution system that uses a potential automation source such as, a scannable license plate of the truck. When a truck driver pulls in at a goods terminal, a scanner scans the license plate by using, for example, an optical character recognition (OCR). Further, the scanned order details linked to the licensed number plate may be relayed, by a computer-readable program, to a commodity terminal. In addition, the computer-readable program may start automatic processing of accounting documents, such as invoices and receivables related to the order. The computer-readable program may, therefore, eliminate various technical errors due to manual goods inputs into a keypad system.

Aspects of the technology of the present disclosure may provide a number of advantages depending on the particular configuration. The technology of the present disclosure may provide a system and method to increase the speed and accuracy of data entry, to decrease billing errors, to increase efficiency and throughput of goods distribution between terminals and retail stations by using above mentioned automation sources.

Aspects in accordance with the technology of the present disclosure may further provide automation sources that may help in automating the whole process of goods distribution, and therefore, a truck driver may never have to enter the terminal office physically. The scanner may intake all order details and a gantry is prepared to output the goods. A truck driver may not even have to step out of the truck during the whole automated process, which may further improve efficiency and throughput for both the truck drivers and the terminals.

According to yet another aspect of the technology of the present disclosure a computer-readable program may generate a Bill of Lading (BOL) that may include all information including destination state for correct taxes.

According to yet another aspect of the technology of the present disclosure a computer-readable program may assist in aggregation of all order related data in order to create a blockchain network whereby transactions are secure and historical information is reliable.

In accordance with aspects of the disclosure, a system for managing goods transportation includes a vehicle configured to transport fuel, a scanner configured to scan an automation source, a processor, and a memory. The vehicle includes a storage tank and/or compartment configured for storage of goods. The memory includes instructions, which, when executed by the processor, cause the system to receive input via a web portal, the input including order details, generate the automation source based on the order details, scan, by the scanner, the automation source, transmit order details to a gantry based on the scanned automation source, and load goods in the storage tank and/or compartment of the vehicle, based on the order details.

In an aspect of the present disclosure, the instructions, when executed by the processor, may further cause the system to communicate to the vehicle a geographic location for delivery of the goods.

In another aspect of the present disclosure, the instructions, when executed by the processor, may further cause the system to cause the vehicle to transport the loaded goods to the geographic location based on the order.

In yet another aspect of the present disclosure, the instructions, when executed by the processor, may further cause the system to deliver the loaded goods to the geographic location.

In a further aspect of the present disclosure, the instructions, when executed by the processor, may further cause the system to transmit a signal indicating delivery acknowledgment.

In yet a further aspect of the present disclosure, the automation source may include a QR code, an RFID, and/or a license plate.

In another aspect of the present disclosure, the QR code may be printed and/or transmitted wirelessly to the vehicle.

In an aspect of the present disclosure, the scanner may include an optical character recognition based license plate scanner.

In yet another aspect of the present disclosure, the scanner may include a Radio Frequency Identifier reader.

In a further aspect of the present disclosure, the instructions, when executed by the processor, may further cause the system to generate a bill of lading.

In accordance with aspects of the disclosure, a computer-implemented method for managing goods transportation, includes receiving input via a web portal, the input including order details, generating an automation source based on the order details, scanning, by a scanner configured to scan an automation source, transmitting order details to a gantry based on the scanned automation source, and loading the goods in a storage tank of a vehicle configured to transport goods such as fuels, chemicals or other physical commodities, based on the order details.

In an aspect of the present disclosure, the method may further include communicating to the vehicle a geographic location for delivery of the goods.

In another aspect of the present disclosure, the method may further include causing the vehicle to transport the loaded goods to the geographic location based on the order.

In yet another aspect of the present disclosure, the method may further include causing the loaded goods to be delivered to the geographic location.

In a further aspect of the present disclosure, the method may further include receiving a signal indicating delivery acknowledgment.

In yet a further aspect of the present disclosure, the automation source may include a QR code, an RFID, and/or a license plate.

In yet a further aspect of the present disclosure, the QR code may be printed and/or transmitted wirelessly to the vehicle.

In yet a further aspect of the present disclosure, the scanner may include an optical character recognition based license plate scanner.

In yet a further aspect of the present disclosure, the scanner may include a Radio Frequency Identifier reader.

In yet a further aspect of the present disclosure, the method may further include generating a bill of lading.

These and other advantages will be apparent from the present application of the aspects described herein.

The preceding is a simplified summary to provide an understanding of some aspects of the technology of the present disclosure. This summary is neither an extensive nor exhaustive overview of the technology of the present disclosure and its various aspects. The summary presents selected concepts of the aspects of the technology of the present disclosure in a simplified form as an introduction to the more detailed description presented below. As will be appreciated, other aspects of the technology of the present disclosure are possible utilizing, alone or in combination, one or more of the features set forth above or described in detail below.

### BRIEF DESCRIPTION OF THE DRAWINGS

The foregoing and other aspects of the aspects disclosed herein are best understood from the following detailed description when read in connection with the accompanying drawings. For the purpose of illustrating the aspects disclosed herein, there is shown in the drawings specific exemplary aspects, it being understood, however, that the aspects disclosed herein are not limited to the specific instrumentalities disclosed. Included in the drawings are the following figures:

FIGS. 1A through 1C illustrates exemplary automation sources, according to aspects disclosed herein;

FIG. 1D illustrates a diagram of a model, according to aspects disclosed herein;

FIG. 2 illustrates a block diagram of a business process for good distribution, according to aspects disclosed herein;

FIG. 3 illustrates a block diagram of a complete distribution system for goods distribution, according to aspects disclosed herein;

FIG. 4 illustrates a front-end and a back-end process flow for goods distribution, according to aspects disclosed herein;

FIG. 5 illustrates a flow diagram for goods distribution from order placement to delivery of the goods by using an automation source, according to an sspect disclosed herein;

FIG. 6 illustrates a flow diagram for goods distribution from a terminal to a retail station by using another automation source, according to another aspect disclosed herein;

FIG. 7 illustrates a flow diagram for goods distribution from a terminal to a retail station by using another automation source, according to yet another aspect disclosed herein;

FIG. 8 illustrates an example hauler portal, according to aspects disclosed herein;

FIGS. 9 and 10 illustrate example order entry portal, according to aspects disclosed herein;

FIG. 11 illustrates an example pricing portal, according to aspects disclosed herein;

FIG. 12 illustrates an example retailer portal, according to aspects disclosed herein; and

FIG. 13 illustrates an example wholesaler portal, according to aspects disclosed herein.

While aspects of the technology of the present disclosure are described herein by way of example using several illustrative drawings, those skilled in the art will recognize the technology of the present disclosure is not limited to the aspects or drawings described. It should be understood the drawings and the detailed description thereto are not intended to limit the technology of the present disclosure to the particular form disclosed, but to the contrary, the technology of the present disclosure is to cover all modification, equivalents and alternatives falling within the spirit and scope of aspects of the technology of the present disclosure as defined by the appended claims.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

While various changes may be made to form different aspects of the technology of the present disclosure, by way of illustration and not limitation a system and method(s) of use of same, embodying the principles of the technology of the present disclosure, can be described in connection with the various figures. All the aspects of the technology of the present disclosure will be described in detail below.

The phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” and “compute,” and variations thereof, as used herein, are used interchangeably and include any type of methodology, process, mathematical operation or technique.

The technology of the present disclosure relates to a goods distribution system and method to automate terminal orders. Aspects of the technology of the present disclosure may utilize a potential automation source such as, but not limited to, a Quick Response Code (QR Code), a Radio Frequency Identifier (RFI) and a license plate, and so forth.

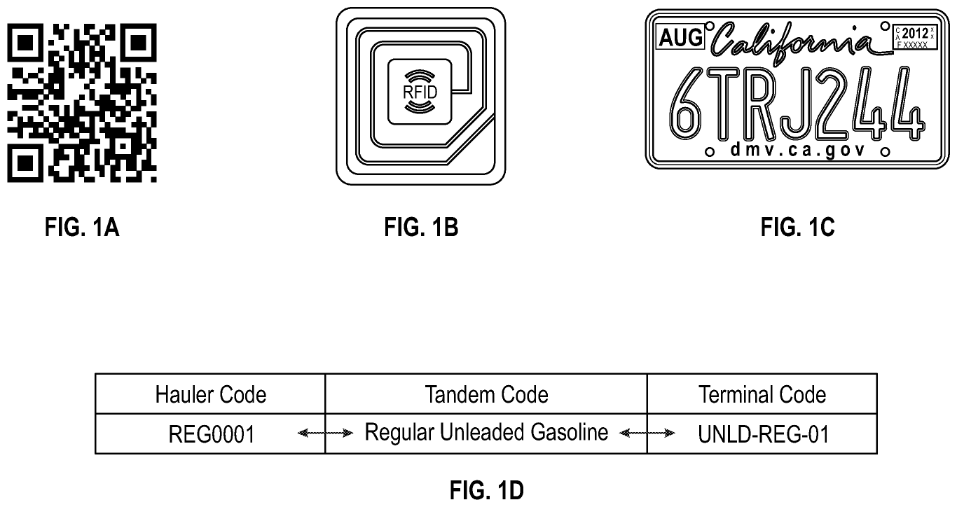

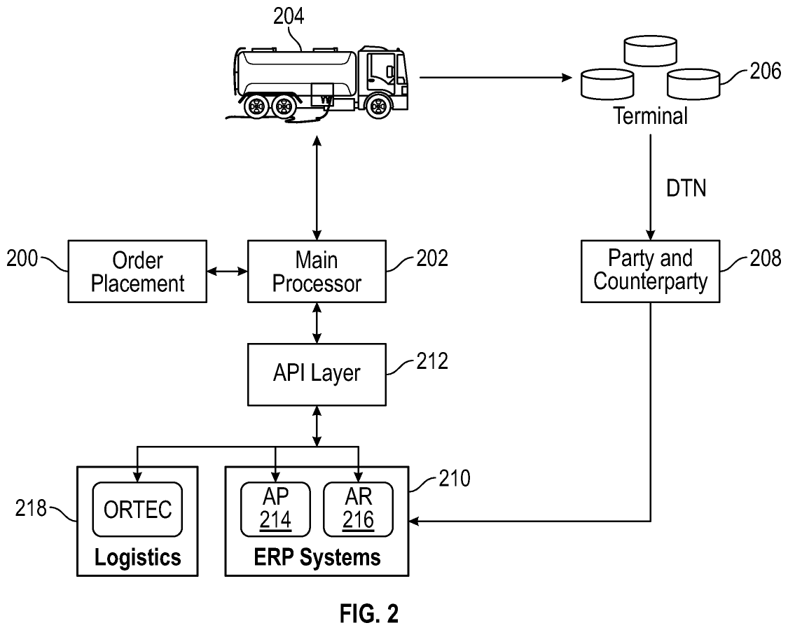

According to an aspect of the technology of the present disclosure, the QR Code is used as an automation source as shown in FIG. 1A. The QR Code is a two-dimensional version of a barcode. In an aspect of the technology of the present disclosure, the QR Code is a matrix barcode, which can be read by using a QR code reader regardless of its orientation for example, sideways, upside-down, diagonally, etc. Generally, barcodes are limited to approximately 20 alpha numeric characters whereas the QR code can hold 350x the information than the barcode can hold. Aspects of the technology of the present disclosure uses the QR code, as the QR code may have an in-built damage correction capability that makes the QR code less susceptible to wear and tear. The QR codes does not require specific device to be scanned as they can be scanned with any device, such as, a smartphone.

In an aspect of the technology of the present disclosure, the QR code may be embedded with order related details of goods, which can be either printed or sent wireles sly to a hauler, for example, a truck tanker driver. Examples of goods may include, but are not limited to, fuel, gas, chemicals, physical commodities such as grain, and so forth. Further, the truck driver may scan the QR code by using any QR Code scanner, and the order related details such as, but not limited to, a goods type, a goods quantity, terminal details, a counterparty to pull goods from, retail station details, etc., may be received by the truck driver. Moreover, the order details of the QR code may be relayed, by a computer-readable program, to a terminal. The order details may be, but are not limited to, what goods to dispense, how much of each of the goods to dispense, and what counterparty to pull from, and so forth. In addition, the computer-readable program may start automatic processing of accounting documents, such as invoices and receivables related to the order at a back-end. The computer-readable program may eliminate various technical errors due to manual goods inputs into a keypad system by a truck driver. The QR code may be printed using in-cab technology or using a mobile device (e.g., a tablet, laptop, or mobile phone). For example, the truck may include in-cab technology, which may include a printer that receives and outputs orders. The printer may be located within the truck's cabin.

According to another aspect of the technology of the present disclosure, a Radio Frequency Identifier (RFI) may be used as an automation source as shown in FIG. 1B. The RFI may be a type of wireless communication, which uses electro-magnetic or electrostatic coupling to uniquely identify an object. The RFI system may consist of three components: a scanning antenna and a transceiver (combined into a reader), a transponder, and a RFI tag. Further, the RFI may be scanned and the order details may be relayed, by a computer-readable program, to a terminal. In addition, the computer-readable program may start automatic processing of accounting documents, such as invoices and receivables related to the order. The computer-readable program may eliminate various technical errors due to manual goods inputs into a keypad system by the truck driver.

According to another aspect of the technology of the present disclosure, a license plate scanning based system may be used as an automation source, as shown in FIG. 1C. When a truck driver enters into the terminal, a scanner reads the license plate by using an Optical Character Recognition (OCR). Further, the scanned order details linked to the licensed number plate may be relayed, by a computer-readable program, to the terminal. In addition, the computer-readable program may start automatic processing of accounting documents, such as invoices and receivables related to the order. The computer-readable program may eliminate various technical errors due to manual goods inputs into a keypad system by the truck driver.

The technology of the present disclosure aims at increasing the speed and accuracy of data entry at the goods terminals. A computer-readable program of the technology of the present disclosure will eliminate the need for the truck driver to manually enter the order details into a conventional keypad system at the terminal, thereby reducing the risk of human errors. The disclosed system may automate all the front-end as well as the back-end processes thus, decreasing potential billing errors and increasing efficiency of the terminals. Currently, on an average, every truck tanker driver takes 5 minutes to enter order details into the system at the terminal. Also, the truck tanker driver is said to be lined up outside of the terminal awaiting their turn, which increases the wait time. In contrast, the use of the disclosed goods distribution system that uses automation sources may reduce this waiting time, and thus, increase loads per day, the throughput of fuel transportation between fuel and gas-related facilities, and so forth.

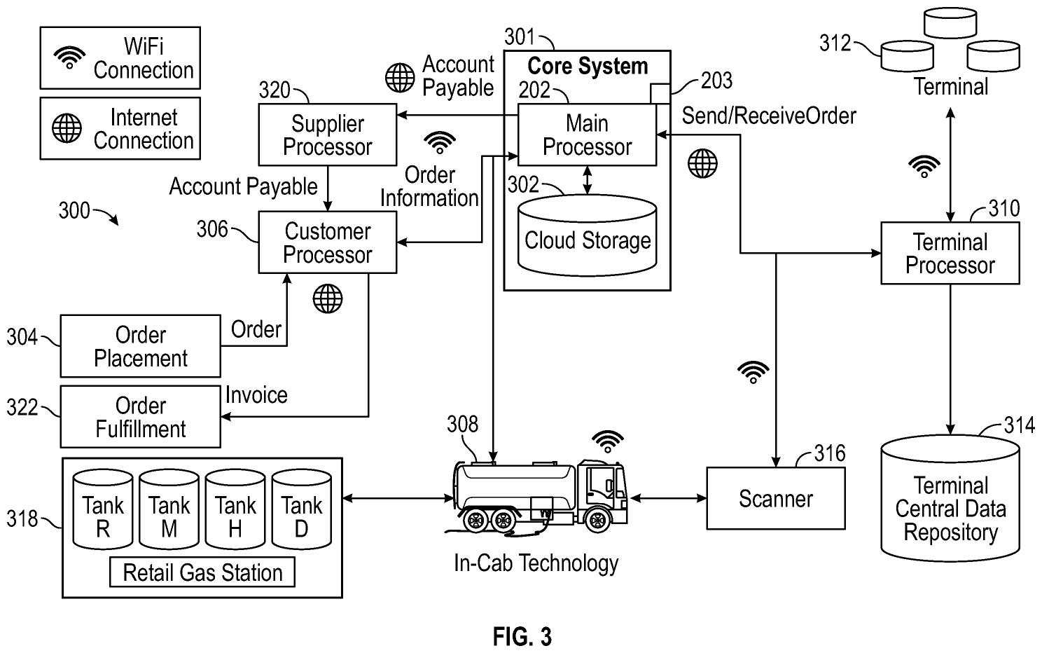

FIG. 2 illustrates a block diagram of a business process for goods distribution, according to aspects disclosed herein. As shown in the figure, at block 200, a customer places an order through a web-portal. In an aspect of the technology of the present disclosure, the web portal may be an online-portal, a web application, a software application, and so forth. As discussed above, the order may include details such as, but is not limited to, a goods type, a goods quantity, terminal details, a counterparty to pull goods from, retail station details, etc. Further, a main processor 202 may receive the order details from the customer and may then generate an automation source such as, but not limited to, a QR code embedded with complete order details. The generated automation source may then be transferred to a truck driver 204 through a communication network. The communication network may include a data network such as, but not restricted to, the Internet, wide area network (WAN), metropolitan area network (MAN), etc. In certain aspects, the network can include a wireless network, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc. In some aspects, the network may include or otherwise cover networks or sub-networks, each of which may include, for example, a wired or wireless data pathway. The network may include a circuit-switched voice network, a packet-switched data network, or any other network capable for carrying electronic communications. For example, the network may include networks based on the Internet protocol (IP) or asynchronous transfer mode (ATM), and may support voice usage, for example, VoIP, Voice-over-ATM, or other comparable protocols used for voice data communications. In one implementation, the network includes a cellular telephone network configured to enable exchange of text or SMS messages.

Examples of the communication network may further include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), the Internet, a global area network (GAN), and so forth. Aspects are intended to include or otherwise cover any type of communication network, including known, related art, and/or later developed technologies.

The truck driver 204 may head towards a fuel terminal 206 as shown. At the terminal 206, the automation source is scanned and all the order related details are relayed to a gantry (e.g., fuel hoses) through the communication network. Further, the truck driver 204 is directed towards a berth at the terminal 206 to load goods, and the order related details including counterparty 208 to load goods from may already be received at the berth through a data transmission network (DTN).

Further, the main processor 202 may interact with an Enterprise Resource Planning (ERP) system 210 through an application programming interface (API) layer 212. The ERP system 210 may hold an account payable (AP) module 214 and an account receivable (AR) module 216 to hold personal accounts either of the dealer or the customer and maintain various sub ledgers such as accounts, currency fluctuation accounts etc. as an integral part of a general ledger (GL). At the same time, the main processor 202 may automate the back-end processing of accounting documents, such as invoices and receivables, etc. The logistic module 214 may utilize any optimization platform for distribution such as, but not limited to, ORTEC modules. According to another aspect of the technology of the present disclosure, the API layer 212 may also be utilized to transmit pricing to any customer who is signed up in the distribution system. In an exemplary aspect, dealers/whole sellers/reseller, etc. may transfer pricing of the goods to their customers through the API layer 212. Another aspect of the technology of the present disclosure may provide an ability to format default invoices generated by the system according to a receiving end's requirement and send invoices from the dealers/whole sellers/reseller to the customers.

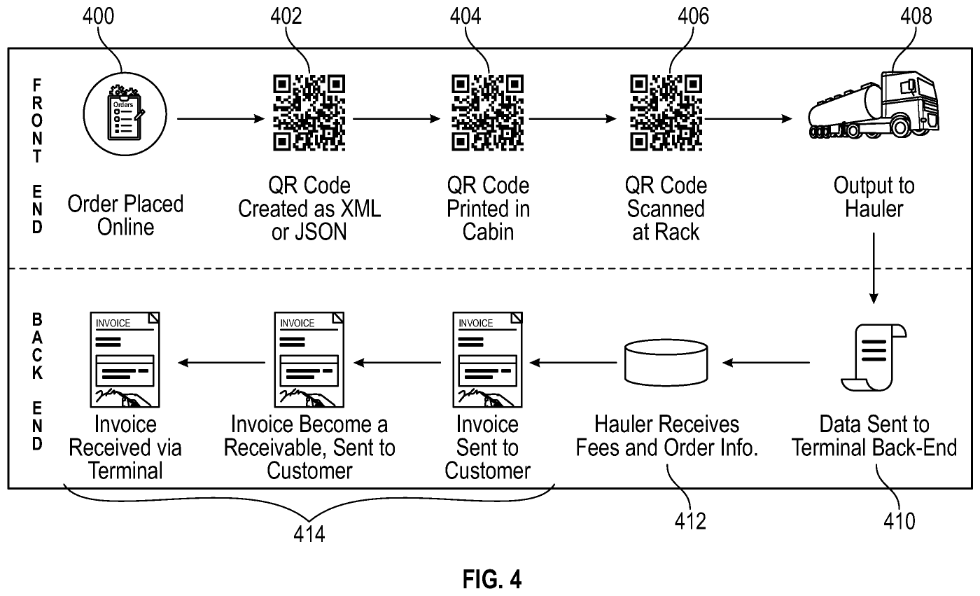

FIG. 3 illustrates a block diagram of a distribution system 300, according to aspects disclosed herein. A core system 301 may consist of the main processor 202 and a cloud storage 302. A customer 304 places an order through a web portal. The order is initially processed by a customer processor 306 and the order details are transferred from the customer processor 306, through a communication network, to the main processor 202. The order related details received at the main processor 202 is stored in the cloud storage 302, as shown in the figure. The main processor 202 may then embed the order related details into an automation source such as, but not limited to, a QR code, a RFI, a License Plate, etc. and transmit it to a truck driver 308. Simultaneously, the order details are transmitted to a terminal processor 310 through the communication network. Further, the terminal processor 310 may communicate with a terminal 312 and a terminal central data repository 314. The terminal central data repository 314 may hold order related details such as, but not limited to, a quantity of goods, a goods type, a bill of lading (BOL), order details, a tax destination, a loading number, etc.

In aspects, the main processor 202 includes a storage and/or memory device 303. The storage and/or memory device is one or more physical apparatus used to store data or programs on a temporary or permanent basis. In some aspects, the controller includes volatile memory and requires power to maintain stored information. In various aspects, the controller includes non-volatile memory and retains stored information when it is not powered. In some aspects, the non-volatile memory includes flash memory. In certain aspects, the non-volatile memory includes dynamic random-access memory (DRAM). In some aspects, the non-volatile memory includes ferroelectric random-access memory (FRAM). In various aspects, the non-volatile memory includes phase-change random access memory (PRAM). In certain aspects, the controller is a storage device including, by way of non-limiting examples, CD-ROMs, DVDs, flash memory devices, magnetic disk drives, magnetic tapes drives, optical disk drives, and cloud-computing-based storage. In various aspects, the storage and/or memory device is a combination of devices such as those disclosed herein.

In various aspects, the memory can be random access memory, read-only memory, magnetic disk memory, solid state memory, optical disc memory, and/or another type of memory. In various aspects, the memory can be separate from the controller and can communicate with the processor through communication buses of a circuit board and/or through communication cables such as serial ATA cables or other types of cables. The memory includes computer-readable instructions that are executable by the processor to operate the controller. In various aspects, the controller may include a wireless network interface to communicate with other computers or a server. In aspects, a storage device may be used for storing data. In various aspects, the processor may be, for example, without limitation, a digital signal processor, a microprocessor, an ASIC, a graphics processing unit (“GPU”), field-programmable gate array (“FPGA”), or a central processing unit (“CPU”).

Further, the truck driver 308, may receive the order related details by scanning the QR code using a personal computing device. Next, the truck driver 308 heads towards the terminal 312 where one of the automation sources such as, but not limited to, the QR code, the RFIs, the license plate is scanned using a scanner 316 when the truck pulls into the fuel terminal 312. The scanner 316 can be any of the scanners known to a person skilled in the art. The order related details may be validated and the truck driver 308 may be directed towards a berth (not shown) from where the goods are to be pulled, and the corresponding order related details are relayed to the berth. After the goods are loaded, the truck driver 308 may head towards a retail station 318 where the goods are unloaded in a designated tank or compartment. The truck driver 308 may scan a lid on the designated tank by using the personal computing device and dispenses the goods. The goods may be dispensed only after matching the details of the scanned data. Next, the truck driver 308 may then receive a digital signature from the customer as an acknowledgement for the delivery and the updated data may be transferred to the main processor 202 along with an out-time of the truck from the retail station 318.

Another aim of the technology of the present disclosure is to automate the back-end processes such as, but not limited to, the generation and transfer of invoices and receivables. The terminal processor 310 is in communication with the main processor 202 and may then generate an order fulfilment acknowledgement from terminal side which may be processed and a supplier processor 320 may complete the funds transfer, the truck relays the information confirmed by the BOL and transmits the related data to the back office where the data is matched to the AP from the supplier. Once the transaction is through, an invoice may be generated and sent to the customer through the customer processor 306 and order is fulfilled at block 322.

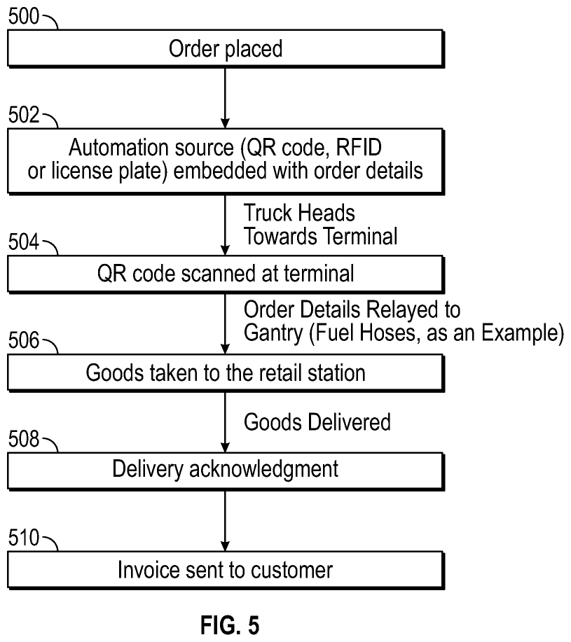

Referring to FIG. 4, shows a step-wise process at both front end and back end of the goods distribution system, according to an aspect of the technology of the present disclosure. At the front end, a customer places an order through a web-portal 400. The order related details are then embedded into a QR code by using XML or JASON 402. The generated QR code may then printed 404 in a cabin of a truck. As the truck pulls into a terminal, the QR code 402 is scanned at a rack 406 and the truck is then directed for pulling the goods from a berth 408.

At the back end of the distribution system 301, order related data scanned through the QR code 402 is sent to the back end terminal 410 where all the processes including fee, order information delivery, invoice, receivables etc. are automated. Further, the fees and the order details are received by the haulers 412, and an invoice 414 is generated, which is then transferred to the customer, which becomes a receivable and is transferred to the customers via terminal through the communication network.

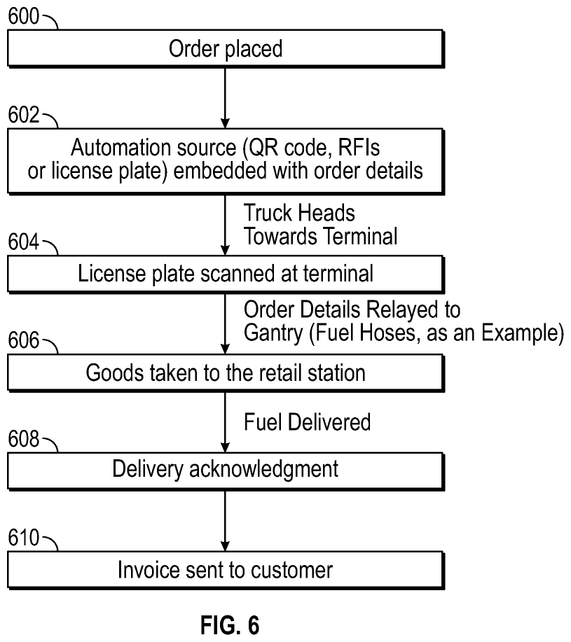

FIG. 5 illustrates a flow diagram for goods distribution from a terminal to a retail station by using an automation source, according to another aspect disclosed herein. At step 500, a customer inputs order details through a web-portal. At step 502, upon receiving the order details a QR code is generated with all the order details, the QR code may be treated as an order ticket. The QR code is either transferred to a truck driver's personal computing device or printed in a cabin of the truck. The truck driver may then head towards a terminal with the QR code.

At step 504, the QR code is scanned at the terminal and all the order details are relayed to a gantry (such as fuel hoses) over a communication network. Further, the truck driver is directed towards a berth at the terminal to load goods in the truck, and simultaneously, all the order details may be transferred to the berth. As shown, at step 506, goods loaded in the truck are further taken to a retail station or end user as guided by the scanned QR code through the driver's personal computing device. The goods are then delivered at the retail station or end-user. An electronic acknowledgement is then generated at step 508. Further, automation of back-end processing of accounting documents, such as invoices and receivables are initiated. Next, at step 510, the generated invoices are sent to the customer.

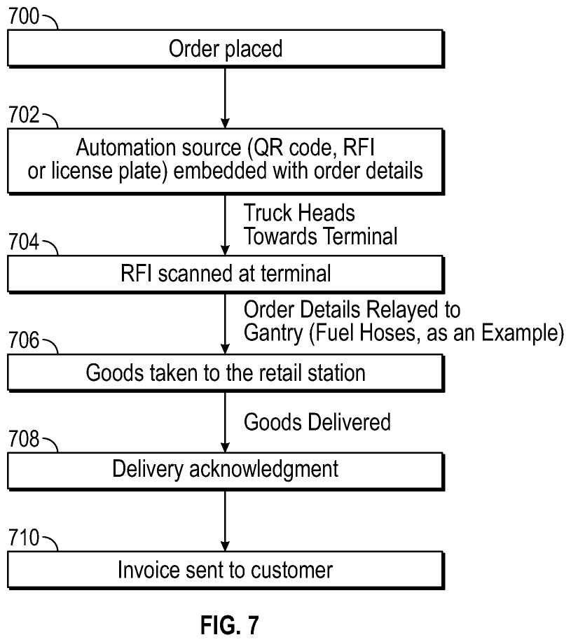

FIG. 6 illustrates a flow diagram for goods distribution from a terminal to a retail station by using another automation source, according to another aspect disclosed herein.

At step 600, a customer inputs order details by using a web-portal. At block 602, upon receiving the order details, a QR code is generated with all the order details, the QR code can be treated as an order ticket. Further, the order details received through the communication network is also linked to a license plate of a truck according to an aspect of the technology of the present disclosure. In addition, the QR code is either transferred to truck driver's personal computing device or printed in the cabin. The truck driver may head towards a terminal with the QR code.

At step 604, when the truck reaches the terminal, a scanner may read the license plate by using optical character recognition (OCR) and the order details are fetched and then sent to a gantry (such as fuel hoses) over a network. Further, the truck driver is directed towards a goods berth at the terminal to load goods in the truck, and simultaneously, all the order details may be transferred to the goods berth.

At step 606, goods loaded in the truck are further taken to a retail station or end-user as guided by the scanned QR code through the driver's personal computing device. The goods are then delivered at the retail station or end-user. An electronic acknowledgement is then generated at step 608. Further, automation of back-end processing of accounting documents, such as invoices and receivables are initiated. Next, at step 610, the generated invoices are sent to the customer.

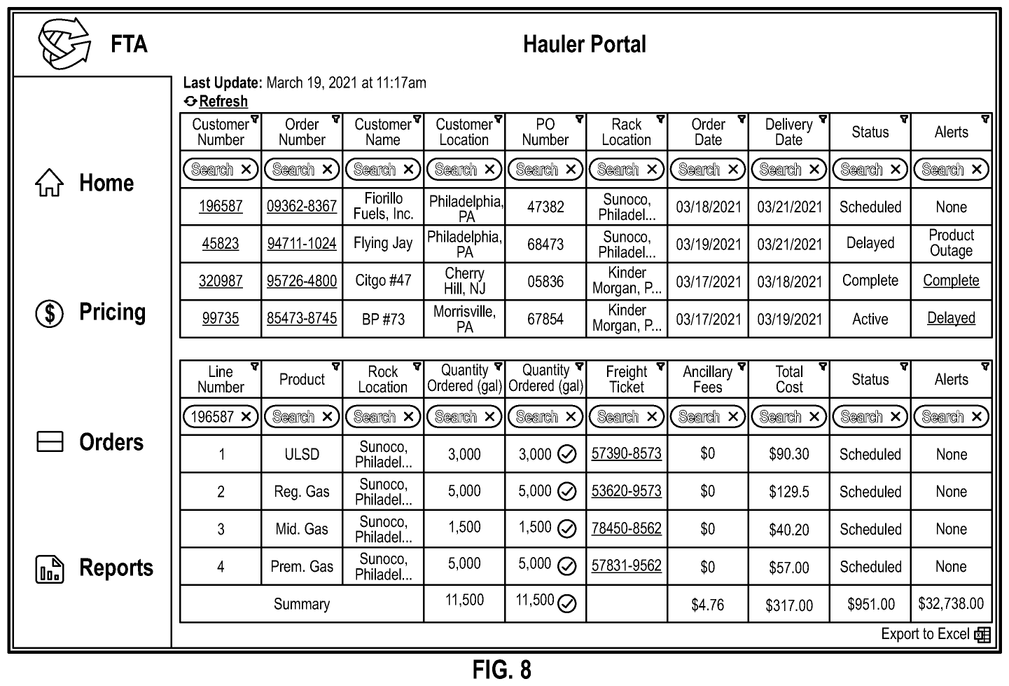

FIG. 7 illustrates a flow diagram for goods transportation from a terminal to a retail station or end-user by using another automation source, according to yet another aspect disclosed herein.

At step 700, the customer inputs order details by using a web-portal. At step 702, upon receiving the order details, a QR code is generated with all the order details, such that the QR code may be treated as an order ticket. The order details received through the communication network are also embedded in a Radio Frequency Identifier (RFI) carried, in any form known to a person skilled in the art, by the truck driver. In addition, the QR code is either transferred to driver's personal computing device or printed in the cabin of the truck tanker.

At block 704, when the truck reaches at the terminal, a scanner may read the RFI, and the order details are then sent to a gantry (fuel hoses) over the communication network. Further, the truck tanker driver is directed towards a goods berth at the terminal to load goods in the truck tanker, and simultaneously, all the order details may be transferred to the goods berth.

At step 706, goods loaded in the truck tanker are further taken to a retail station as guided by the scanned QR code through the driver's personal computing device. The goods are then delivered at the retail station. An electronic acknowledgment is then generated at step 708. Further, automation of back-end processing of accounting documents, such as invoices and receivables are initiated. Next, at step 710, the generated invoices are sent to the customer.

According to yet another aspect of the technology of the present disclosure, the automation sources may help in automating the whole process, the truck driver may never have to enter the terminal office (terminal order entry room) physically as a valet service may be provided. At a scanning station, a scanner may intake all order details and the gantry may be prepared to output the goods. Therefore, the truck driver does not have to step out of the truck as terminal as an attendant may aid to attach the hoses or gantry for transfer. This further improves efficiency and throughput for both the haulers and the terminals because the driver does not have to get out of his truck.

According to yet another aspect of the technology of the present disclosure, a Bill of Lading (BOL) may now have all information, including destination state for correct taxes, when the BOL is generated at the terminal. The BOL may be automatically updated with details of the destination state and the corresponding state's tax details when the truck driver may send the information at the back end system. The updated information may also be embedded into the BOL, and the BOL may be automatically matched to the account payable (AP) that was received by the back-end system for hassle-free transaction.

According to yet another aspect of the technology of the present disclosure, all the data transferred within the system is stored in cloud storage. The data may be properly managed at the back-end system for efficient and hassle-free transactions. For this purpose, aggregation of data is done in order to create a blockchain network whereby transactions are secure and historical information is reliable. In aspects, the disclosed technology may operate as a blockchain network, built off a blockchain framework such as Hyperledger Fabric. The blockchain framework may be used in enterprise settings between multiple businesses, capturing an immutable distributed ledger of transactions that reduces the risks of fraud and manipulation while bolstering informational security and facilitating financial transactions/reconciliations. By reducing paperwork and errors, blockchain helps significantly reduce overhead and transaction costs without the need for third parties or middlemen to verify transactions. Historically, companies have stayed away from using distributed ledgers to avoid sharing transactional information with customers and competitors. The blockchain framework solves this problem by using private channels, which are restricted messaging paths that provide privacy for specific subsets of network members. All data is invisible to members of the network who are not granted permission to access it. In aspects, network members control what information may be visible to each organization or member and what actions each can take.

The disclosed technology has the benefit of enabling real-time order reconciliation. A blockchain distributed ledger allows for all data to exist within one central data repository, while chaincodes and permissions ensure that no one stakeholder can see another stakeholder's data. Chaincodes define the data schema in the distributed ledger, initialize it, perform updates when triggered by applications, and respond to queries. Currently, much of the reconciliation processes in the midstream distribution industry involve holding two physical sheets of paper side-by-side (the Bill of Lading and Delivery Receipt) to ensure that product specifications and quantities are correct. The processes that include two separate sheets of paper are the consequence of having siloed databases, separately belonging to each stakeholder, without an effective means of communication. The disclosed technology solves this problem by using a distributed ledger (blockchain). With a distributed ledger, order specifications can either be reconciled or flagged in real-time without any stakeholders having to share any sensitive data with one another. As used herein, stakeholders may include terminals, haulers, wholesalers, suppliers, retailers, and/or suppliers. As such, stakeholders can significantly reduce spend on back-office staff, paper and printing, and achieve a much lower rate of credit and rebills.

The disclosed technology provides security. Blockchain technology is secure as it is decentralized and distributed. There is no single point of failure, which makes it much harder to corrupt and hacking into one part of the system cannot affect other parts. The disclosed system will use private channels, which are restricted messaging paths that provide privacy for specific subsets of network members. All data is invisible to members of the network who are not granted permission to access it. Network members control what information each organization or member may see, and what actions each can take. Each of the disclosed system's stakeholders may have their own subset network within the overall network, enabling the system's stakeholders to control permissions of who sees what information. Members of each permissioned network can interact with the network using chaincode. To enable these permissioned networks, the blockchain framework provides a membership identity service that manages the user IDs and authenticates all participants on the network. Access control lists can be used to provide additional layers of permissions through the authorization of specific network permissions. As an example, a specific user ID may be permitted to invoke a chaincode application, but be blocked from deploying a new chaincode. This permission network also assigns network roles by nodes and associated node types. There are two types of node types within the blockchain framework network (1) peer nodes are responsible for executing and verifying transactions, and (2) ordering nodes are responsible for ordering transactions and propagating the correct history of events to the network.

All aspects of the blockchain network may be controlled by the administrator. Chaincodes enable the use of smart contracts, which are simply programs stored on a blockchain that run when predetermined conditions are met. Every node that participates in the database shares a complete copy of the database and contributes consensus to the validation of each node as it changes. Not only does consensus enhance security, but if a node fails or falls under attack, such as a distributed denial-of-service, the remaining nodes continue to function. It is extremely difficult to attack and disable every node.

The disclosed technology enables the use of smart contracts. Smart contracts may be used to automate the execution of an agreement so that all participants can be immediately certain of the outcome, without any intermediary's involvement or time loss. Smart contracts can also automate a workflow, triggering the next action when conditions are met. Within the midstream fuel distribution market, there are any number of contracts governing the terms and conditions of a transaction between two parties, requiring entire teams of legal analysts and compliance officers. Instead of each network member (i.e., counterparty) having its own business logic (and own database), the businesses share the business logic and all sign off on changes to the database. In the fuel distribution industry, contracts and offtake agreements are monitored closely by entire teams of legal personnel. With the blockchain network, these contracts become much easier to monitor, and expensive legal staff might not be necessary for this function.

The disclosed technology has the benefit of immutability. Because a blockchain transaction is immutable, members of the network cannot go back to a transaction and change any of its elements. This mitigates the risks of stakeholders tampering with transactions for personal benefit. The immutable and chronological nature of blockchain data can itself be audited to maintain business or industry compliance, as well as serve as a key element of governance across the business.

A Canonical Data Model (CDM) is a design pattern used to communicate across different data formats. Using a CDM1 will enable effective communication between stakeholders, who otherwise have different data elements representing the same products or other entities. As an example, a hauler might have the product code “REG0001” for regular gasoline, while a terminal uses product code “UNLD-REG-01” for that same product. The canonical model will have its own product code in a middle mapping layer, such as “Regular Unleaded Gasoline” which will be mapped to both the hauler and terminal's codes to create a communication bridge (FIG. 1D).

Use of this canonical model enables stakeholders to communicate with one another quickly and effectively. Stakeholders will need to keep their product codes and other data elements up to date and must map those elements to a primary mapping layer. There is currently no solution in the marketplace that effectively bridges data entity communication gaps between terminals, haulers, suppliers, retailers, and wholesalers.

The combination of the CDM and the blockchain network as used in the disclosed technology is what bridges the gaps in communication and facilitates the real-time order reconciliations that have previously been so difficult to come by.

The system provides stakeholders with the benefit of data validations throughout the ecosystem. The data validations include:

Data element matchings: Ensuring that products, quantities, suppliers, etc. from a front-run order (via the hauler) match the order that a hauler scans into the system upon showing up to the terminal berth.

Capacity matching: Ensuring that an order that is placed via a wholesaler, hauler, or retailer, does not exceed a normal order amount, rendering it an anomaly. An example of this would be if a stakeholder typically places an over for 8,000 gallons, but a new order comes in for 80,000 gallons. In this instance, a stakeholder likely input an additional zero by accident, otherwise known as a fat-finger entry. This can lead to an overfill at the rack, whereby a hauler compartment overflows and product begins spilling onto the terminal grounds. This involves having to shut down the entire terminal until all products are cleaned and the situation is resolved. Conversely, a hauler might enter 800 gallons instead of 8,000, creating an underfill. In this instance, a hauler might drive off to deliver the fuel only to realize their mistake. They will have to return to the terminal, wait in line again, and get the remaining 7,200 gallons. This significantly impacts the hauler's fleet utilization. To create its anomaly detection, In aspects, an artificial intelligence model may be used to effectively catch errors at the source. The artificial intelligence model may be trained on prior data.

Compartment Matching: Haulers typically operate with fleets of tankers that have a varying number of compartments and compartment sizes. The disclosed system will help to ensure that compartments are aligned with the ordered quantities by running back-end validations to ensure that each compartment is not about to be overfilled with a product. As an example, a hauler might typically send truck A, whose ‘compartment 1’ can hold 5,000 gallons of a product. If an order is placed for 5,000 gallons in compartment one, but a different truck, whose compartment 1 only holds 3,000 gallons, there is the risk of an overfill, which will shut down the rack and cost the hauler in terms of cleanup fees, fleet utilization, customer satisfaction, and more. This same type of incident can also result from a fat finger incident, whereby the intention was to put 5,000 gallons into compartment one, but 50,000 was input instead.

Another benefit of the disclosed technology is that suppliers will be able to better optimize their inventories with the real-time and front-run data coming in from the system.

The disclosed system may provide advanced analytics based on a combination of the blockchain framework and the canonical model. The analytics may include:

(1) Truck load sequencing at terminals, which is enabled through streamlining data across the blockchain & canonical data model in order to best schedule truck appointments across all different hauler fleets to better optimize the in-flow of trucks based on the product availability at the terminal and product demand from the haulers. Load sequencing is the practice of directing trucks as to which fuel (or general commodity) berth that a driver should go to. Not all berths have the same products and many berths cannot have a truck discharging the same fuel on either side of a berth. The disclosed technology enables a terminal to sequence loads to more effectively position trucks (or any general transport device, such as rail cars, ships, etc.) to get the trucks in and out quicker.

(2) Leveraging artificial intelligence and machine learning models on top of the blockchain and canonical model in order to provide cross functional & cross stakeholder reporting in order to enhance operations between all parties. The artificial intelligence and machine learning models may include, for example, linear regression, logistic regression, decision tree, time-series, support vector machine (SVM), Naive Bayes, K-nearest neighbors, K-means, Random forest algorithm, gradient boosting, Forward State Space Planning (FSSP), Backward State Space Planning (BSSP), image classification, reinforcement learning, optimal classification tree method, mixed integer programming, and/or linear optimal classification tree. The system may enable the automation of any and all operational tasks between all stakeholders (e.g., terminals, wholesalers, suppliers, retailers, and/or haulers) based on the analytics and the blockchain framework.

The disclosed technology may be used to optimize vehicle (e.g., truck) routes and can reduce order input errors. For example, the system will eliminate order input errors by creating an integration layer that captures orders, parses the data and adds a QR code to all printed order tickets. The system will offer a front-end portal for order entry but users can also continue to use their existing order system, which will be integrated with a canonical data model. A canonical data model is a type of data model that aims to present data entities and relationships in the simplest possible form in order to integrate processes across various systems and databases. Non-static-emitting scanners may be connected to the same rack hardware as the keypad and drivers can simply scan their code rather than type in an entire order. Orders can be front-run to the terminals and haulers will be notified if products are not available. Once a driver scans a QR code at the rack, the system will verify with the terminal's systems that the orders match and the output process will begin. Once the output process is completed, an electronic BOL will be transmitted via API to the system, allowing stakeholders to easily access the document. Terminals will be open to allowing the system to install scanners because they improve the terminal's throughput. With accurate order entry at the rack, the rest of the fuel distribution ecosystem will benefit from digitized order documentation and clean data.

Once a delivery is made and the retail operator has signed the delivery receipt, the system can automatically reconcile the delivery receipt to the BOL. If there are no discrepancies, the system will then reconcile the AP (terminal to wholesaler) to the AR (wholesaler to retailer) before drafting an invoice and sending the invoice to the retailer. To draft an invoice, the users may provide pricing information as well as the margin added to the rack price. This will likely involve sourcing rack prices from DTN (a market intermediary for regional pricing information) and obtaining the wholesaler's margin formulas. This provides an additional benefit, where wholesalers and haulers can reduce back-office headcount and reduce their spend on printers, paper, ink, and postage. All order data, including financials, will be housed within the system, giving stakeholders a secure and reliable central repository for their data.

With accurate order inputs and reconciled financials, the system may act as centralized data repository that can be integrated with other tools and applications, such as ERP systems, scheduling tools and more. Many haulers and wholesalers still operate via on-premise hardware and lack the ability to scale with growth. Users can begin harnessing their data via reporting and analytical tools to help business leaders make real-time, proactive decisions without having to purchase more hardware and hire database administrators. The system may include customized reporting to help users with reporting and compliance.

The system can ensure effectiveness of the data and integrity of the data through the disclosed system. For example, when a customer, supplier, hauler, and/or terminal enters an address into the system they will be validated for correct information against Google (R) maps or the USPS (R) address files if the address is incorrect, the address will be flagged up as an error and rejected back to the source system. In another example, when ordering goods the quantity must match to the haulers truck compartments. For example, a quantity of nine thousand gallons may comply with the tanker truck compartment. In a case where the quantity does not match, then the system will reject the order. In another example, the system may ensure the quantity that is received from wholesale company equals the terminal lift into the truck, and also equals the amount delivered to the customer. If this quantity is incorrect, the system will send the order back to the source systems to resolve prior to completing the order and released back to the ordering entity so the billing of the product can happen, and AP can happen.

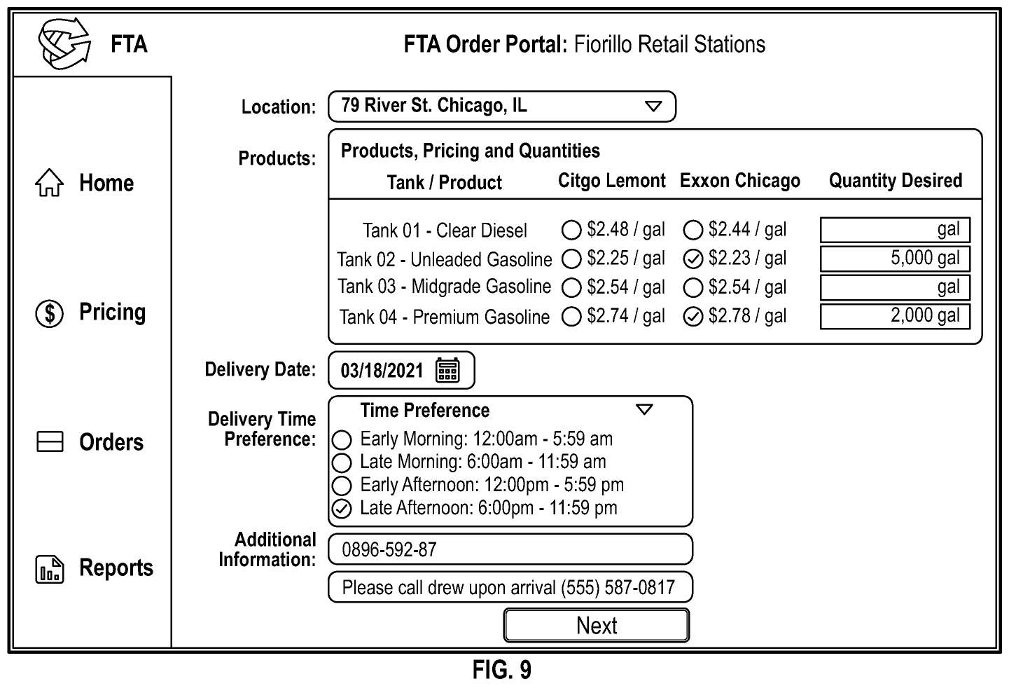

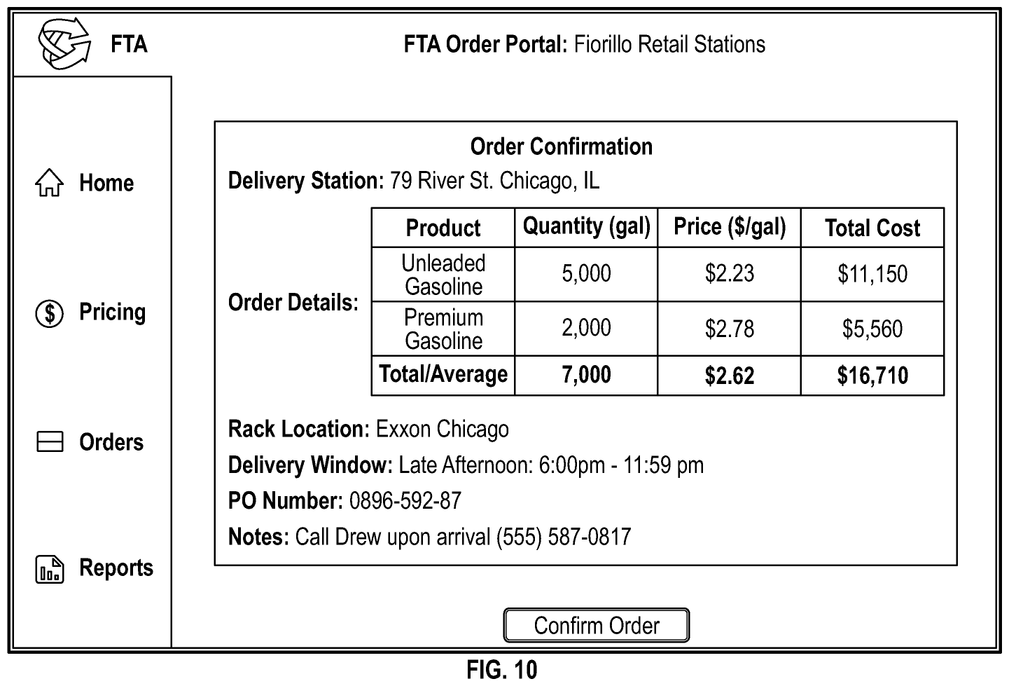

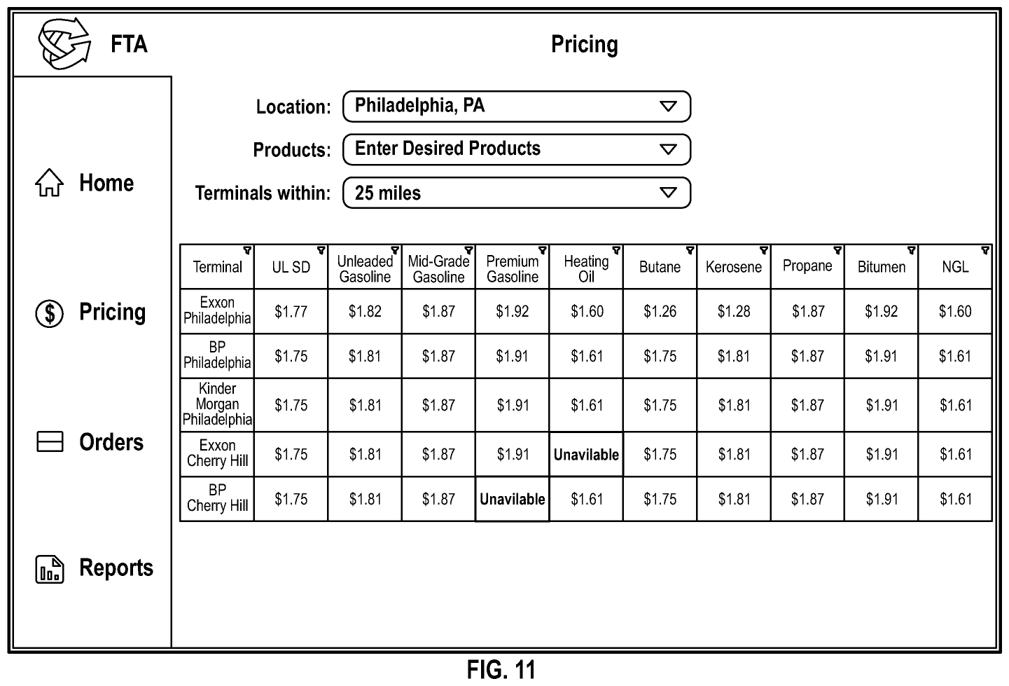

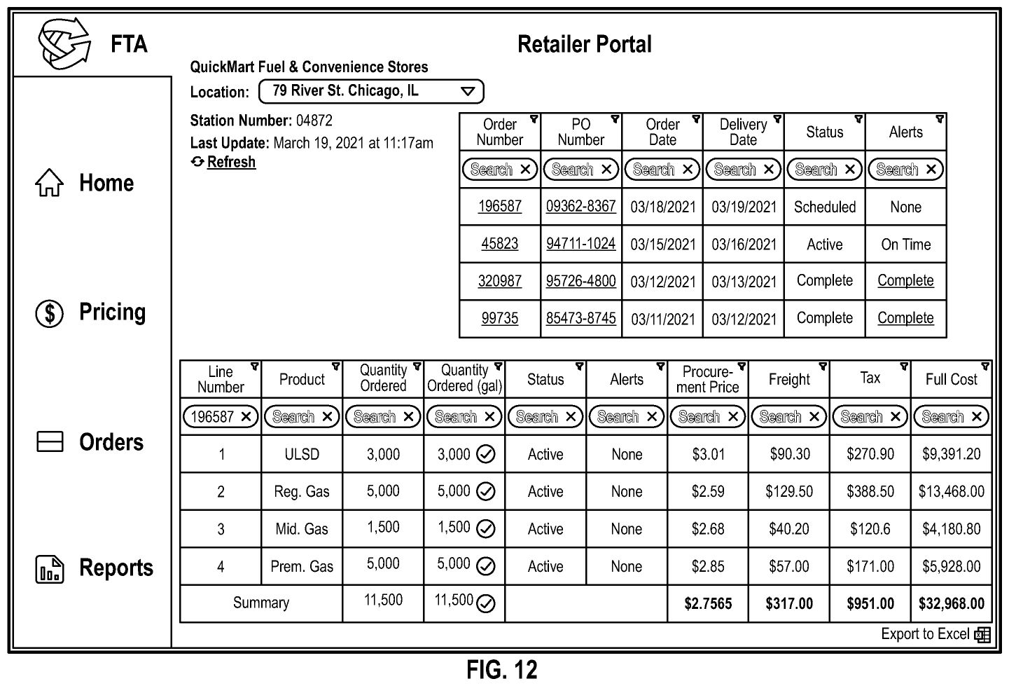

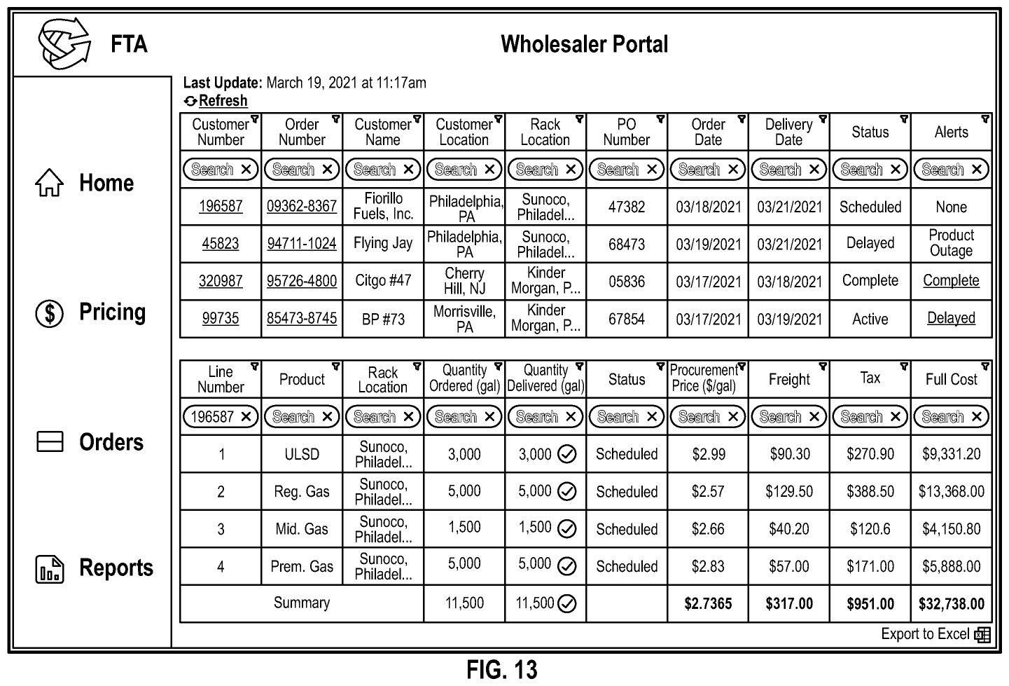

FIGS. 8-13 illustrate various example web portals of the disclosed systems and methods. FIG. 8 shows an example hauler portal. FIGS. 9 and 10 illustrate example order entry portal. FIG. 11 shows an example pricing portal. FIG. 12 illustrates an example retailer portal. FIG. 13 illustrates an example wholesaler portal. Although a web portal is shown, it is contemplated that orders may be received via phone and/or fax and may use OCR to interpret the order and enter the order into the system.

The aspects of this technology of the present disclosure have been described in detail. However, to avoid unnecessarily obscuring the technology of the present disclosure, the preceding description omits a number of known structures and devices. This omission is not to be construed as a limitation of the scope of the technology of the present disclosure. Specific details are set forth by use of the aspects to provide an understanding of the technology of the present disclosure. It should however be appreciated that the technology of the present disclosure may be practiced in a variety of ways beyond the specific Aspects set forth herein.

A number of variations and modifications of the technology of the present disclosure can be used. It would be possible to provide for some features of the technology of the present disclosure without providing others.

The technology of the present disclosure, in various aspects, configurations, and aspects, includes components, methods, processes, systems and/or apparatus substantially as depicted and described herein, including various Aspects, sub-combinations, and subsets thereof. Those of skill in the art will understand how to make and use the technology of the present disclosure after understanding the present disclosure. The technology of the present disclosure, in various aspects, configurations, and aspects, includes providing devices and processes in the absence of items not depicted and/or described herein or in various aspects, configurations, or aspects hereof, including in the absence of such items as may have been used in previous devices or processes, e.g., for improving performance, achieving ease and/or reducing cost of implementation.

The foregoing discussion of the technology of the present disclosure has been presented for purposes of illustration and description. It is not intended to limit the technology of the present disclosure to the form or forms disclosed herein. In the foregoing Detailed Description, for example, various features of the technology of the present disclosure are grouped together in one or more aspects, configurations, or aspects for the purpose of streamlining the disclosure. The features of the aspects, or configurations may be combined in alternate aspects, configurations, or aspects other than those discussed above. This method of disclosure is not to be interpreted as reflecting an intention the technology of the present disclosure requires more features than are expressly recited in each claim. Rather, as the following claims reflect, inventive aspects lie in less than all features of a single foregoing disclosed aspect, or configuration. Thus, the following claims are hereby incorporated into this Detailed Description, with each claim standing on its own as a separate aspect of the technology of the present disclosure.

Moreover, though the description of the technology of the present disclosure has included description of one or more aspects, or configurations and certain variations and modifications, other variations, combinations, and modifications are within the scope of the technology of the present disclosure, e.g., as may be within the skill and knowledge of those in the art, after understanding the present disclosure. It is intended to obtain rights which include alternative Aspects or configurations, to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system for managing goods transportation, comprising:
a vehicle configured to transport goods, the vehicle including:
at least one of a storage tank or compartment configured for storage of the goods;
a scanner configured to scan an automation source;
a processor; and
a memory, including instructions, which, when executed by the processor, cause the system to:
receive input including order details;
generate the automation source based on the order details;
cause the automation source to be scanned by the scanner;
causing the order details to be transmitted to a gantry based on the scanned automation source;
record the order details in a distributed ledger; and
cause the goods to be loaded in the associated at least one storage tank or compartment of the vehicle, based on the order details.

2. The system of claim 1, wherein the instructions, when executed by the processor, further cause the system to communicate to the vehicle a geographic location for delivery of the goods.

3. The system of claim 2, wherein the instructions, when executed by the processor, further cause the system to cause the vehicle to transport the loaded goods to the geographic location based on the order.

4. The system of claim 3, wherein the instructions, when executed by the processor, further cause the system to deliver the loaded goods to the geographic location.

5. The system of claim 1, wherein the instructions, when executed by the processor, further cause the system to transmit a signal indicating delivery acknowledgment.

6. The system of claim 1, wherein the automation source includes at least one of a QR code, an RFID, or a license plate.

7. The system of claim 6, wherein the QR code is printed or transmitted wirelessly to the vehicle.

8. The system of claim 6, wherein the scanner includes an optical character recognition based license plate scanner.

9. The system of claim 1, wherein the scanner includes a Radio Frequency Identifier reader.

10. The system of claim 1, wherein the instructions, when executed by the processor, further cause the system to generate a bill of lading.

11. A computer-implemented method for managing goods transportation, comprising:
receiving input including order details;
generating an automation source based on the order details;
scanning, by a scanner configured to scan an automation source;
transmitting order details to a gantry based on the scanned automation source;
recording the order details in a distributed ledger; and
cause the goods to be loaded in at least one of a storage tank or compartment of a vehicle configured to transport the goods, based on the order details.

12. The computer-implemented method of claim 11, further comprising communicating to a vehicle navigation system of the vehicle a geographic location.

13. The computer-implemented method of claim 12, further comprising causing the vehicle to transport the loaded the goods to the geographic location based on the vehicle navigation system.

14. The computer-implemented method of claim 13, further comprising causing the loaded goods to be delivered to the geographic location.

15. The computer-implemented method of claim 14, further comprising receiving a signal indicating delivery acknowledgment.

16. The computer-implemented method of claim 11, wherein the automation source includes at least one of a QR code, an RFID, or a license plate.

17. The computer-implemented method of claim 16, wherein the QR code is printed or transmitted wirelessly to the vehicle.

18. The computer-implemented method of claim 16, wherein the scanner includes an optical character recognition-based license plate scanner.

19. The computer-implemented method of claim 11, wherein the scanner includes a Radio Frequency Identifier reader.

20. The computer-implemented method of claim 11, further comprising generating a bill of lading.
